(19) United States
(12) Patent Application Publication
(10) Pub. No.: US 2015/0122053 A1
(43) Pub. Date: May 7, 2015

(54) Pitot tube designs for compressible and incompressible fluid flow with viscosity and turbulence

(71) Applicant: Harold James Willard, JR., Washington, DC (US)

(72) Inventor: Harold James Willard, JR., Washington, DC (US)

(21) Appl. No.: 13/998,496

(22) Filed: Nov. 6, 2013

(51) Int. Cl. G01F 1/46

(52) U.S. Cl. CPC G01F 1/46
USPC 73/861.66

(57) ABSTRACT

This invention presents a Pitot tube design and methodology for determining the flow characteristics of fluids in subsonic and supersonic flow, including the effects of viscosity and turbulence. A new methodology, the Two-Fluid Theory, is developed which treats a real fluid as being composed of two ideal fluids: an inviscid fluid and a Poiseuille fluid. The resulting expression for flow velocity is applicable to a real fluid of any viscosity and to pipes of any L/D ratios, including entrance effects.

Two designs, comprising annular, smooth-bore tubes, with devices for measuring total and static pressures, are presented: one for incompressible flow; one for compressible, supersonic flow. Allowance is made for the viscous component of the flow to become fully developed, in accordance with the Theory.

### BRIEF DESCRIPTION OF THE FIGURES

FIG. 1. Schematic of pitot tube insulated for compressible, supersonic fluid flow.

FIG. 2. Measured Saybolt viscometer results (Ref. 2): Time to drain 60 cc of fluid through a capillary tube as a function of kinematic viscosity; calculations from Two-Fluid Theory with and without turbulence.

FIG. 3. Measured fluid height in a tank draining through a smooth tube of diameter 0.35 cm and length 16.7 cm as a function of time for water and olive oil at approximately room temperature. Curves are Two-Fluid Theory calculations with and without turbulence and for water as an inviscid fluid.

FIG. 4. Calculated fluid velocities from Two-Fluid Theory and from using inviscid fluid expression for air at 12,000M and at standard temperature and pressure as a function of differential Pitot tube pressure (L=10 cm; Lₑ=1 cm; a=0.25 cm).

FIG. 5. Calculated fluid velocities from Two-Fluid Theory for water and for a fluid having a density of water and a viscosity four times that of water as a function of differential Pitot tube pressure, at about room temperature. Also shown is the velocity calculated from the inviscid fluid expression (L=10 cm; Lₑ=1 cm; a=0.25 cm).

FIG. 6. Two-Fluid Theory calculations for subsonic air flow at 288° K and zero altitude, with viscosity and turbulence. Also shown are results assuming air is an inviscid incompressible fluid and an inviscid compressible fluid. (Lₑ=1 cm; L=10 cm; a=0.25 cm; Pitot tube of FIG. 1.)

FIG. 7. Two-Fluid Theory calculations for subsonic air flow at 223.3° K and at an altitude of 10,000M, with viscosity and turbulence. Also shown are results assuming that air is an inviscid fluid. (Pitot tube of FIG. 1: Lₑ=1 cm; L=10 cm; a=0.25 cm)

FIG. 8. Two-Fluid Theory calculations for supersonic air flow at 288° K and zero altitude, with viscosity and turbulence. (Le=1 cm; L=10 cm; a=0.25 cm; Pitot tube of FIG. 1.)

FIG. 9. Two-Fluid Theory calculations for supersonic air flow at 233° K and an altitude of 10,000M, with viscosity and with turbulence. (Lₑ=1 cm; L=10 cm; a=0.25 cm; Pitot tube of FIG. 1.)

FIG. 10. Illustrative Two-Fluid Theory Pitot tube calculations for air at 10,000M altitude, with various viscosities; (Ps=26.4 Pa; T=223.3K; P=0.4136 Kg/M³; L=10 cm; Lₑ1 cm; a=0.25 cm, Cs=300M/s.) Also shown are results for air as an incompressible, inviscid fluid. (Pitot tube of FIG. 1.)

FIG. 11. Schematic of Pitot tube for incompressible, subsonic fluid flow.

### SPECIFICATION

### References to Prior Applications

1. Incompressible flow: Provisional Appl. No. 61/272,342, Sep. 15, 2009 Utility patent application Ser. No. 12/923,102, Sep. 2, 2010
2. Compressible flow: Provisional Appl. No. 61/272,763, Oct. 30, 2009 Utility patent application Ser. No. 12/923,673, Oct. 4, 2010

### REFERENCES CITED

(1) The Handbook of Fluid Dynamics, Richard W. Johnson, Ed., CRC Press, 1998, Section 33.3.
(2) Hunsaker, J. C. and Rightmire, B. C., Engineering Applications of Fluid Mechanics, McGraw-Hill, New York, 1947, Chap. VIII.
(3) Patton, M. and Wiggert, D. C., Fluid Mechanics, Schaum's Outlines, McGraw-Hill, 2008,
(4) Copyright 2009, Harold James Willard, Jr.

### U.S. PATENT DOCUMENTS

(1) U.S. Pat. No. 7,478,565 B2 Young
(2) U.S. Pat. No. 6,584,830 B2 Long
(3) U.S. Pat. No. 5,483,839 A Meunier
(4) U.S. Pat. No. 5,969,266 A Mahoney, et al
(5) U.S. Pat. No. 6,901,814 B2 Vozhdaev, et al

### STATEMENT REGARDING FEDERALLY SPONSORED RESEARCH OR DEVELOPMENT

not applicable

### THE NAMES OF PARTIES TO A JOINT RESEARCH AGREEMENT

not applicable

### INCORPORATION-BY-REFERENCE OF MATERIAL SUBMITTED ON A COMPACT DISC

not applicable

### BACKGROUND OF THE INVENTION

(1) Field of the Invention

This invention deals with the determination of subsonic and supersonic flow characteristics of incompressible and compressible fluids as determined from Pitot tube measurements interpreted with a new Two-Fluid Theory for flow in pipes.

(2) Background Art

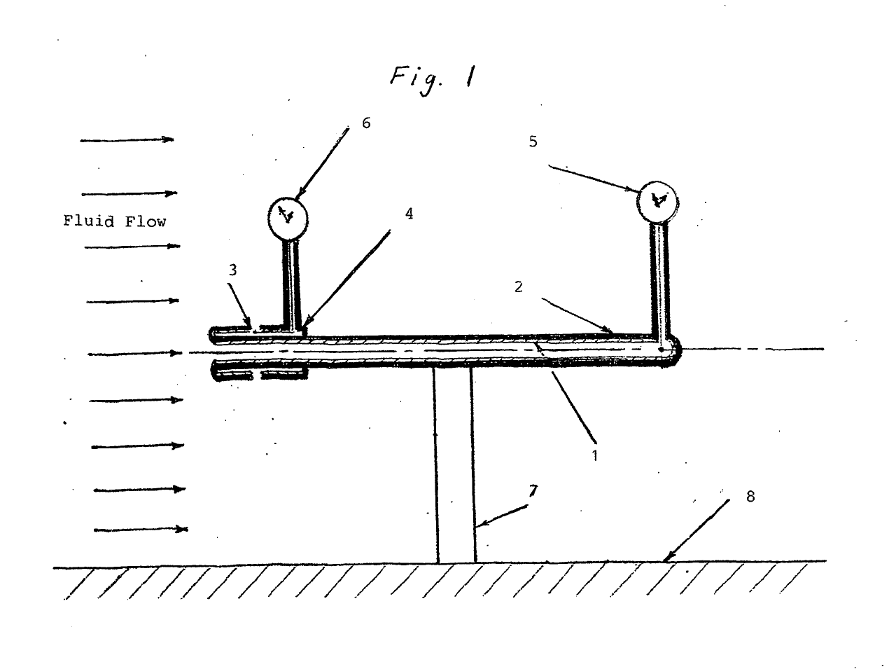

One of the most important devices for measuring flow characteristics characteristics is the Pitot tube, shown schematically in FIG. 1 in its application to an external flow field. Such devices, in various forms, are used routinely for flows inside tubes and in channels, for gases and liquids. A very important application of Pitot tubes is the measurement of the speed of aircraft relative to wind speed.

However, the analytical methodology heretofore used to assess flow characteristics such as pressure and velocity from Pitot tube data has been based upon the assumption that the fluid is either inviscid, which is strictly true only for superfluid. helium, or for a fluid with an unrealistically high viscosity (Poiseuille fluid) (Ref. 1). Real fluids of finite viscosities can exhibit fluid flow behavior which differs greatly from that predicted for these extremes. The present invention corrects these deficiencies.

There are over 1500 references to Pitot tubes in the Patent Office data bank. As examples of current practice, five recent patents are considered. In Long (U.S. Pat. No. 6,584,830B2/2003), a device is presented to measure the viscosity of a flowing fluid used in processing chemicals in the photography industry. The inventor uses the equation for a Poiseuille fluid (Eqn. 5) and also that for an inviscid fluid (Eqn. 6) in the same analysis. The resulting equation (Eqn. 7) used to justify the device combines both equations and is semi-empirical. It seems likely that the sensitivity of the device to viscosity exhibited is. due to other causes (vortex behavior and if well understood might lead to an enhancement of its performance.

In Young (U.S. Pat. No. 7,478,565/2009), an apparatus is presented for fluid flow rate and density measurements. Equation 27 uses the relationship for an inviscid fluid in the derivation of flow rate, Eqns 29 and 30. However, the device is intended to be used with real liquids and gases. The kinematic viscosity of air, (dynamic viscosity divided by density), is comparable to that of water and both exhibit very significant deviations from inviscid fluid behavior. Again, an analysis based on real fluid behavior might yield improve performance.

Meunier (U.S. Pat. No. 5,483,839/1996) presents a multi-Pitot tube assembly for measurement of fluid characteristics surrounding a test structure. If the device is to be used to determine the velocity distribution in the flow field, it will be necessary to have a methodology for converting differential pressure from the Pitot tubes into fluid velocity. The analytical method to be used is not presented in the patent; however, if it is based upon Benouilli's equation, which assumes zero viscosity, significant errors could result. If experimental calibrations are used, difficult and time-consuming effort will be necessary without a theory for guidance. The Two-Fluid Theory, presented in the present invention, provides a means for guiding the design of such experiments and in the analysis of results.

Mahoney, et al (U.S. Pat. No. 5,969,266/1999) present a flow meter Pitot tube with temperature sensor for measuring flow in a pipe. No discussion is presented on how the pressure readings will be converted to velocities of the fluid. As with Meunier, above, without a suitable theory for guidance, current analytical methodology based upon Bernouilli's equation, or in the case of highly viscous flow, Poiseuille's equation, an analysis of the measurements can be fraught with error and the design of experiments to calibrate the instrument difficult and less effective than if a suitable theory is available for guidance.

Vozhdaev, et al (U.S. Pat. No. 6,901,814 B2/2005) present a Pitot-static tube for use in determining flight parameters such as angle of attack and velocity from pressure measurements made at various locations on the device. The analytical methodology for converting pressure measurements to velocities is not given; therefore, the assumptions used in the theoretical calculations of drag coefficients and angle of attack are not evident. If an inviscid fluid analysis has been used, as is common in the field, the results could be in significant error when applied to real fluids having finite viscosities and under conditions in which turbulence exists. Both of these are included in the Two-Fluid Theory developed for the present invention.

### BRIEF SUMMARY OF THE INVENTION

This invention presents Pitot tube designs and methodology for determining the flow characteristics of incompressible and compressible fluids in subsonic and supersonic flow which include the effects of viscosity and turbulence in the analysis. Pitot tubes and other flow measuring devices now based on differential pressure-velocity relationships assume either an inviscid fluid or a fluid having an unrealistically high viscosity (Poiseuille fluid) in the analyses and calibration of their performance. Furthermore, the effect of turbulence on flow behavior is not considered, which can greatly affect the performance of the device.

In the present invention, a methodology, called the Two-Fluid Theory, is developed and supported by experimental data, which treats a real fluid as being composed of a mixture of two ideal fluids: an inviscid fluid and a fluid having a very high viscosity (Poiseuille fluid). The resulting expressions for flow velocity in pipes are applicable to real fluids of any viscosity and to tubes of any length-to-diameter ratio, including entrance effects, for subsonic or supersonic flow. Additionally, the effect of turbulence is included in the analysis.

The methodology is applied to Pitot tube designs comprising smooth bore hollow tubes of length 10 cm and internal diameter 0.5 cm, opened at one end to fluid fields in either subsonic or supersonic flow; connected to a pressure measuring device at the opposite end to measure total pressure; surrounded by an annulus of 0.25 cm differential radius, sealed at both ends and connected to a pressure measuring device to measure static pressure; made of stainless steel, titanium, or other metal or material appropriate for the fluid being measured; tube walls are insulated for supersonic, compressible fluid flow to achieve adiabatic conditions and length of the annulus is abbreviated to minimize heat loss (to 4 cm); small bore holes are positioned around the circumference of the annuli. and 1 cm from the flow entrance in accordance with the new methodology to ensure that the viscous component of the flow is fully established; temperature measuring devices can be positioned at the static and total pressure measuring stations to confirm that adiabatic conditions are met for compressible fluid flow, which are not required for the device used for incompressible fluid flow since isothermal conditions are satisfactory, rendering Pitot tubes for such applications much simpler to fabricate, operate and maintain.

### DETAILED DESCRIPTION OF THE INVENTION

FIG. 1 is a schematic of a Pitot tube conforming to this invention, which is to be manufactured in accordance with current practice from a smooth tube (1) of steel, titanium, or other metal or material selected for the environment in which the device is to be employed. The schematic shows the Pitot tube affixed to a support (7) attached to a surface (8), which could be the surface of an aircraft, land or water vehicle, or the inside of a pipe or conduit, or anyplace else where Pitot tubes are employed.

The fluid direction is shown parallel to the axis of the tube. If the fluid impinges at an angle θ to the tube, the component of the velocity along the tube axis, V.cos θ, is to be applied in the analysis in lieu of V.

The length of support (7) is such that disturbance of the flow due to proximity of the wall is not significant.

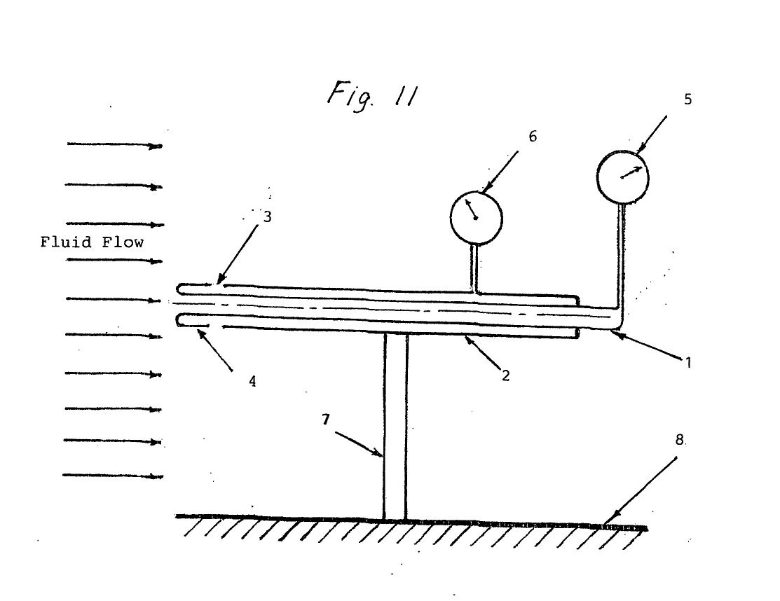

The Pitot of FIG. 1 is intended for compressible fluid flow into the supersonic flow regime and is insulated to achieve adaibatic conditions, assumed in the analysis. The device intended for subsonic, incompressible fluid flow operates under isothermal conditions and therefore it does not have to be insulated (FIG. 11).

In the discussion, the following definitions apply:
V(r,z) (cm/s) fluid velocity; (cm/s);
d (cm) inner diameter of the Pitot tube; (cm);
a (cm) inner radius of the Pitot tube; (cm);
L (cm) active length of the tube, from the openings at (3) to the elbow (cm); (4) is the static pressure chamber;
Lₑ(cm) entrance length selected to ensure that a Poiseuille velocity distribution for the viscous component of the fluid flow is fully developed;
z (cm) distance in direction of flow inside tube;
   (gms/cc) density of the fluid;
   (dynes/cc) dynamitic viscosity of the fluid;
   (cm²/s) kinematic viscosity of the fluid;
Pₛ (dynes/cm²) static pressure of the fluid;
Pₒ (dynes/cm²) stagnation pressure of the fluid;
ΔP (dynes/cm²) pressure change in the pipe;
M Mach number
cₚ (ergs/gm ° K) specific heat at constant pressure
cᵥ (ergs/gm ° K) specific heat at constant volume
R (ergs/° K mole) gas constant
K cₚ/cᵥ
Tₛ (° K) temperature (static)
ΔT (° K) temperature change

The designs of the Pitot tubes in this invention are based upon a new theory, the Two-Fluid Theory (Reference 4), for the flow of fluids in pipes developed by the inventor. A brief discussion of the theory follows.

The equation governing the steady-state flow of fluids in pipes in the absence of work or heat is attributed to Euler (1752-55), Navier (1822), and Stokes (1845, 51):

$$ρ \cdot V ( r , z ) \cdot \frac{α V ( r , z )}{α z} = - \frac{α P}{α z} + \frac{M}{r} \frac{α }{α r} \{ r \cdot \frac{α V ( r , z )}{α r} \} + \frac{{α}^{2} V ( r , z )}{α {z}^{2}} \qquad ( 1 )$$

Although an exact closed-form solution to Equation (1) is not forthcoming, an approximate solution is given by

$$V ( r , z ) = \frac{α ( z ) \cdot β ( r , z )}{α ( z ) + β ( r , z )} , \qquad ( 2 )$$

in which α(z), the solution for an inviscid fluid, μ=0, is

$$( α z ) = \sqrt{\frac{2 \cdot Δ P}{ρ} \cdot ( \frac{z}{L} )} \qquad ( 3 )$$

The solution for very highly viscous fluid, neglecting the term

$$V ( r , z ) \cdot \frac{α V ( r , z )}{α z} ,$$

is given by

β(r,z)=βₒ·(1−r²/a²), (4)

in which βₒ(r,z) is given by

$${β}_{o} ( r , z ) = \frac{Δ P \cdot {a}^{2}}{4 \cdot μ \cdot L} ( 1 - {e}^{- 2 z / \sqrt{{a}^{2} - {r}^{2}}} ) \qquad ( 5 )$$

As an approximation to greatly simply the analysis, the value of βₒ(r,z) at the centerline will be used, which represents the maximum z dependence,

$${β}_{m} ( z ) = \frac{Δ P \cdot {a}^{2}}{4 \cdot μ \cdot L} \cdot ( 1 - {e}^{- 2 z / a} ) . \qquad ( 6 )$$

The bracketted term represents the build-up of the Poiseuille component of the fluid velocity to its steady-state value, an entrance effect which must be included in the design.

The average velocity over the cross section of the pipe at distance z is

$$\begin{matrix}\overline{V ( z )} = \frac{1}{π \cdot {a}^{2}} \cdot {\int }_{o}^{a} 2 \cdot π \cdot r \cdot V ( r , z ) \cdot d r \\ = α ( z ) \cdot \{ 1 - \frac{ln ( 1 + {β}_{m} ( z ) / α ( z )}{{β}_{w} ( z ) / α ( z )} \}\end{matrix} \qquad ( 7 )$$

For this work, z=L, and 2L/a=80, rendering the exponential term in Equation 6 negligible. Note that in the limit of zero viscosity V [symbol] α. For very high viscosity, V [symbol] β m/2.

Equation (7) applies to flow in the absence of turbulence. The Navier-Stokes Equation, Equation 1, is clearly inadequate to account for turbulence in its present form. Additional forces exist internal to the system which lead to instability and loss of energy from the linear flow field. Experimental observations of turbulence reveal the following characteristics: (1) turbulence exists because of viscosity, but is also suppressed by viscosity; (2) turbulence results in a loss of energy in the linear flow field which appears to saturate: i.e. the flow is not choked off nor does turbulence die off over long distances after once established; (3) turbulence does not persist when the Reynolds number (V·2a/ν) is reduced to less than about 2000, but does not necessarily initiate when Rₑ is raised to 2000; under quiescent conditions it may be delayed until much higher Reynolds numbers are attained; (4) highly viscous flow is completely free of turbulence and is largely unaffected by surface roughness and other irregularities in pipes.

From these considerations, a reasonable representation for turbulence is to assume that in the turbulent state the same function for velocity applies as in the normal state, but with the inviscid fluid component only modified. Thus,

$$\begin{matrix}{V}_{t} ( r , z ) = \frac{{α}_{t} ( r , z ) \cdot {β}_{m} ( z )}{{α}_{t} ( r , z ) + {β}_{m} ( z )} \\ and & ( 8 ) \\ \overline{{V}_{t} ( z )} = {α}_{t} ( z ) \cdot \{ 1 - \frac{Ln ( 1 + {β}_{m} / {α}_{t} ( z ) )}{{β}_{m} ( z ) / {α}_{t} ( z )} \} & ( 9 )\end{matrix}$$

in which the subscript t refers to the turbulent state for the inviscid component of the flow.

From energy considerations, a reasonable representation for the turbulent velocity component is, at z=L,

$${α}_{t} ( z ) = α ( z ) \cdot {\{ 1 - {η ( \frac{1 + {β}_{m} ( z ) / α ( z )}{{β}_{m} ( z ) / α ( z )} )}^{2} \cdot {e}^{- τ / {β}_{m} ( z ) / α ( z )} \}}^{0.5} \qquad ( 10 )$$

in which [symbol] and [symbol] are constants determined from experiment. For a a smooth pipe, [symbol] =2. [symbol] accounts for turbulence entrance effects,

η(2L/a)=0.85(1−0.4 e^{-L/9a}−0.6 e^{-L/150a}) (11)

To apply the theory to compressible fluid flow, it is postulated that the same approach followed for incompressible flow is valid. The assumptions are that an ideal gas exists and that reversible adiabatic processes occur. The latter condition requires that the tube be insulated. Furthermore, an entrance length, Lₑ, is specified such that the Poiseuille velocity distribution is achieved at the entrance to the active part of the tube.

For subsonic, ideal gas, isentropic fluid flow, (Ref. 3),

$$\frac{{P}_{o}}{{P}_{s}} = {( 1 + \frac{k - 1}{2} {M}^{2} )}^{k / k - 1} \qquad ( 11 )$$

Solving for ΔP yields, where ΔP=P−Pₛ,

$$Δ P = {P}_{s} [ {( 1 + ( \frac{k - 1}{2} ) {M}^{2} )}^{k / k - 1} - 1 ] . \qquad ( 12 )$$

This pressure difference applies to the expressions for both the inviscid and viscous fluid components.

Similarly, for supersonic flow, the pressure change is given by the Raleigh pitot tube formula, (Ref. 3),

$$Δ P = {P}_{s} \{ \frac{{[ ( \frac{k + 1}{2} ) {M}^{2} ]}^{k / k - 1}}{{[ \frac{2 k}{k + 1} {M}^{2} - ( \frac{k - 1}{k + 1} ) ]}^{1 / k - 1}} - 1 \} \qquad ( 13 )$$

The sound velocity, used in determining the Mach number, is

Cₛ=\sqrt{kRT} (14)

in which k=1.4, R=287 J/KG·K; T=temperature (° K). The temperature change is given by (Ref. 3):

$$Δ T = {T}_{s} \{ \frac{( 1 + \frac{k - 1}{2} {M}^{2} ) ( \frac{2 k}{k - 1} {M}^{2} - 1 )}{\frac{{( k + 1 )}^{2}}{2 ( k - 1 )} {M}^{2}} - 1 \} \qquad ( 15 )$$

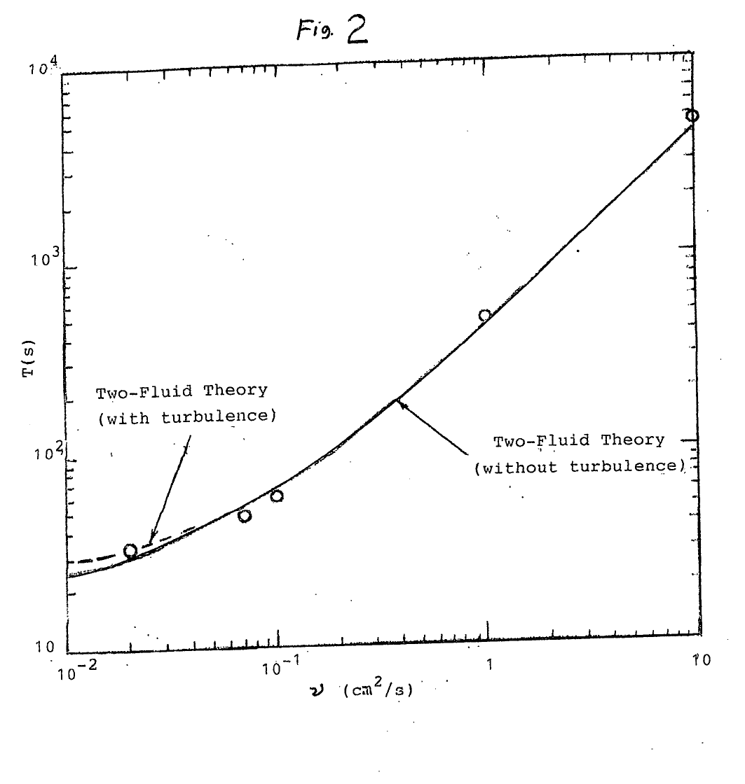

FIG. 2 presents the results of the 2-F Theory applied to Saybolt viscometer data (Reference 2), demonstrating that the methodology is valid for a full range of viscosity. In the Saybolt tests, the time required for 60 cc of fluid of various viscosities to drain through a capillary tube is measured.

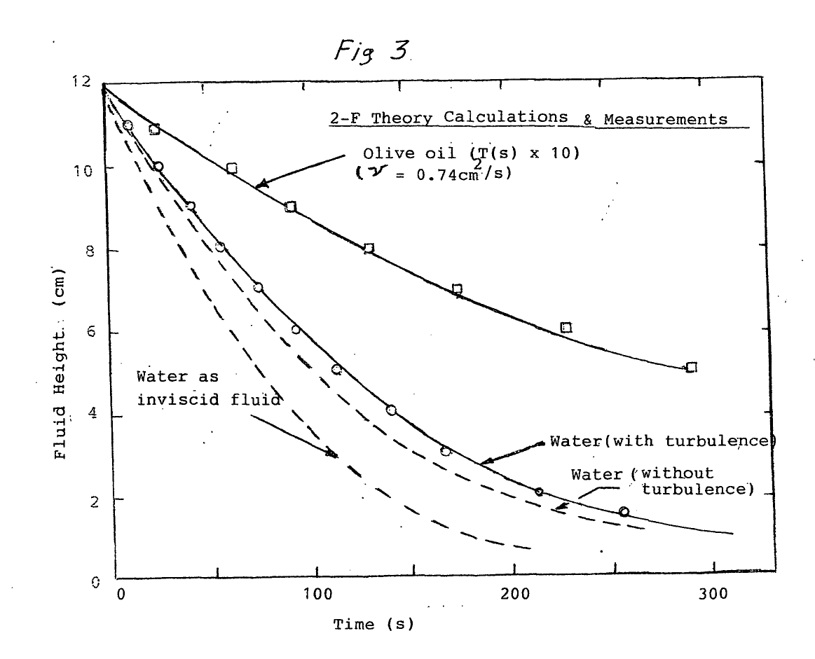

FIG. 3 presents the application of the 2-F Theory to the flow of water and olive oil through a smooth tube of 0.35 cm diameter and 16.7 cm length. Height of the fluids in a tank measured as a function of time are well represented by the theory. Olive oil (ν=0.74 cm²/s) is highly viscous, exhibiting Poiseuille behavior under these conditions. Water (ν=0.01 cm²/s) is more nearly inviscid, but still retains significant viscous effects. Additionally, the effect of turbulence is evident (Reynold's number 2700 at maximum height). Calculations for water as an inviscid fluid, and without turbulence, are also shown, demonstrating that both make significant contributions to the flow behavior. These results illustrate the validity of the 2-F Theory for extremes of viscosity and for turbulence.

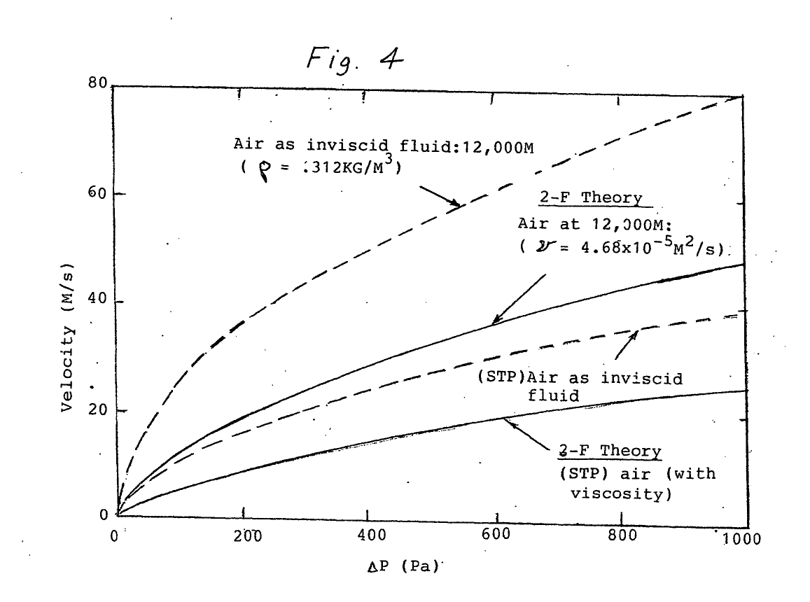

FIG. 4 shows calculated velocities expected for a Pitot tube of FIG. 1 with L=10 cm, Lₑ=1 cm and a=0.25 cm, for air at 12,000M and at standard temperature and pressure (STP). For comparison, the velocities as a function of differential pressure assuming air is an inviscid fluid are also shown. At a differential pressure of 400 Pa, the velocity predicted from Eqn. 2 for an inviscid fluid is 1.7 times that for real air at 12000M and 1.6 times that for real air at STP. Air is essentially incompressible for these conditions.

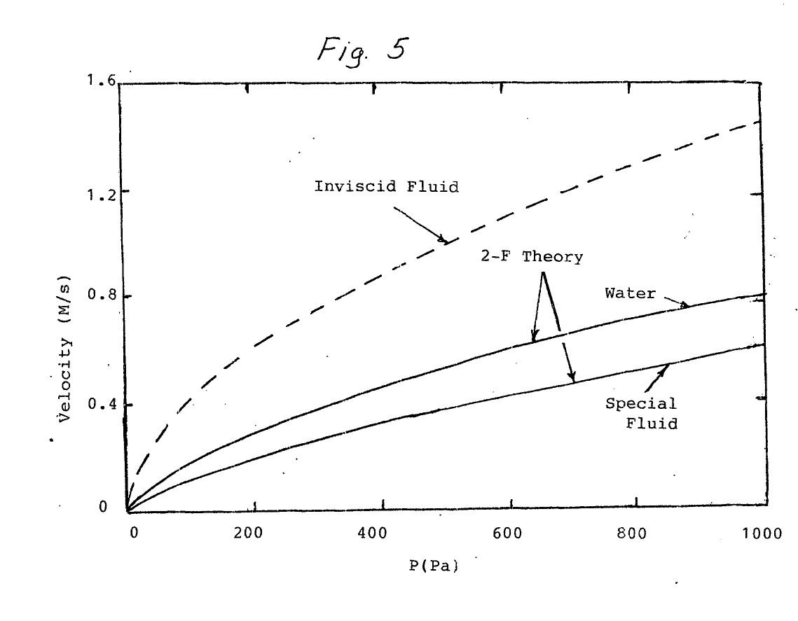

FIG. 5 presents similar calculations for water at STP and for a special fluid having a density of water and a viscosity four times that of water, at STP. For water, the ratio of inviscid flow velocity to real flow velocity is 1.8. For the special fluid, it is 2.5.

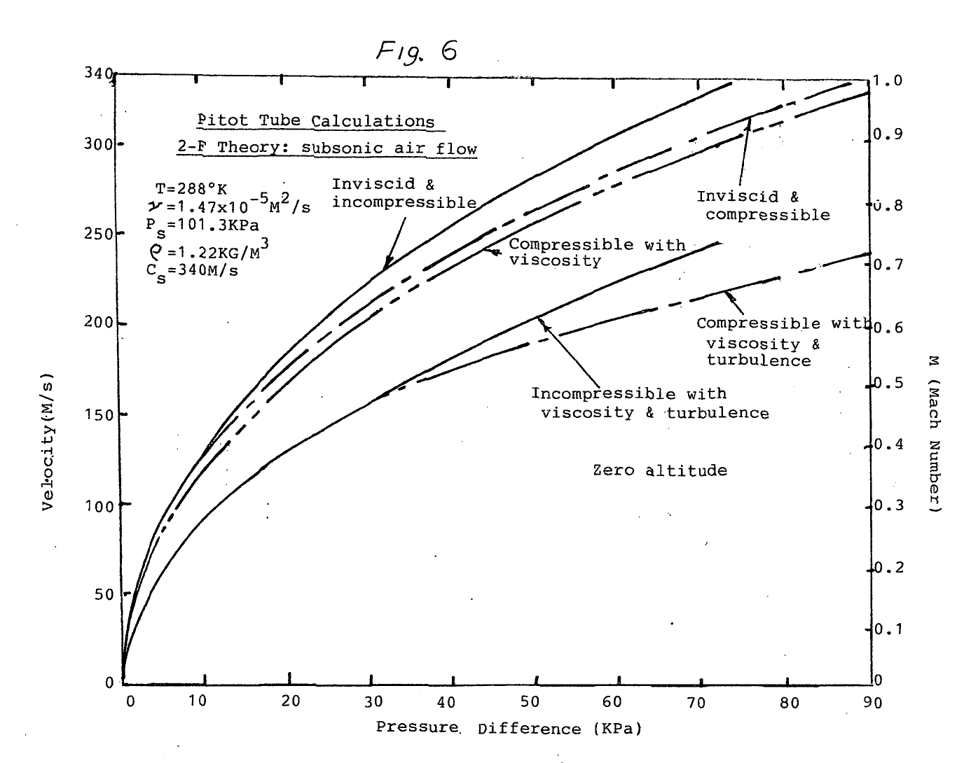

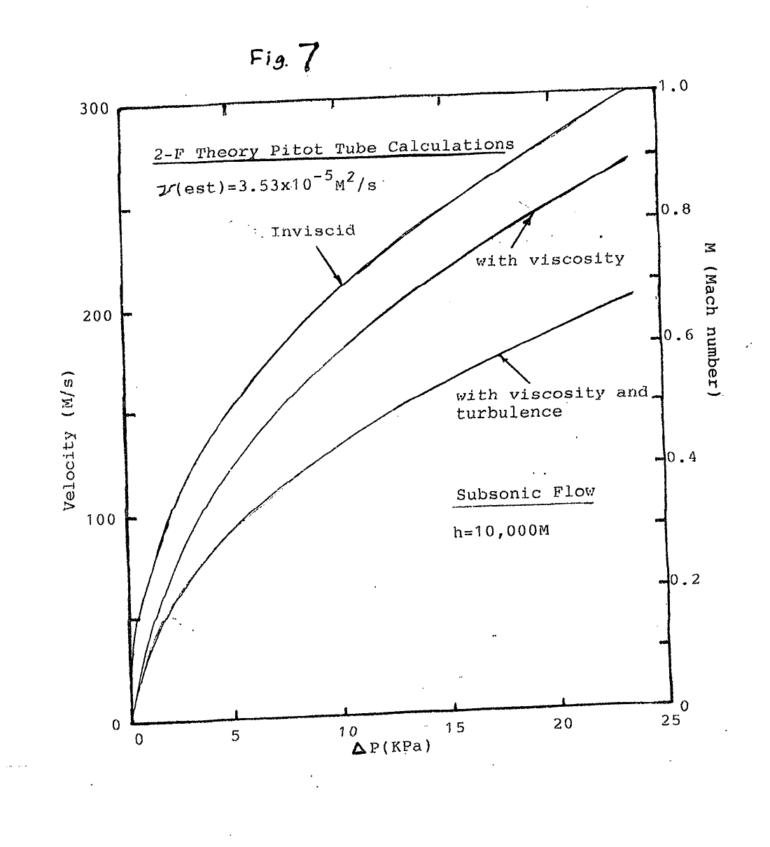

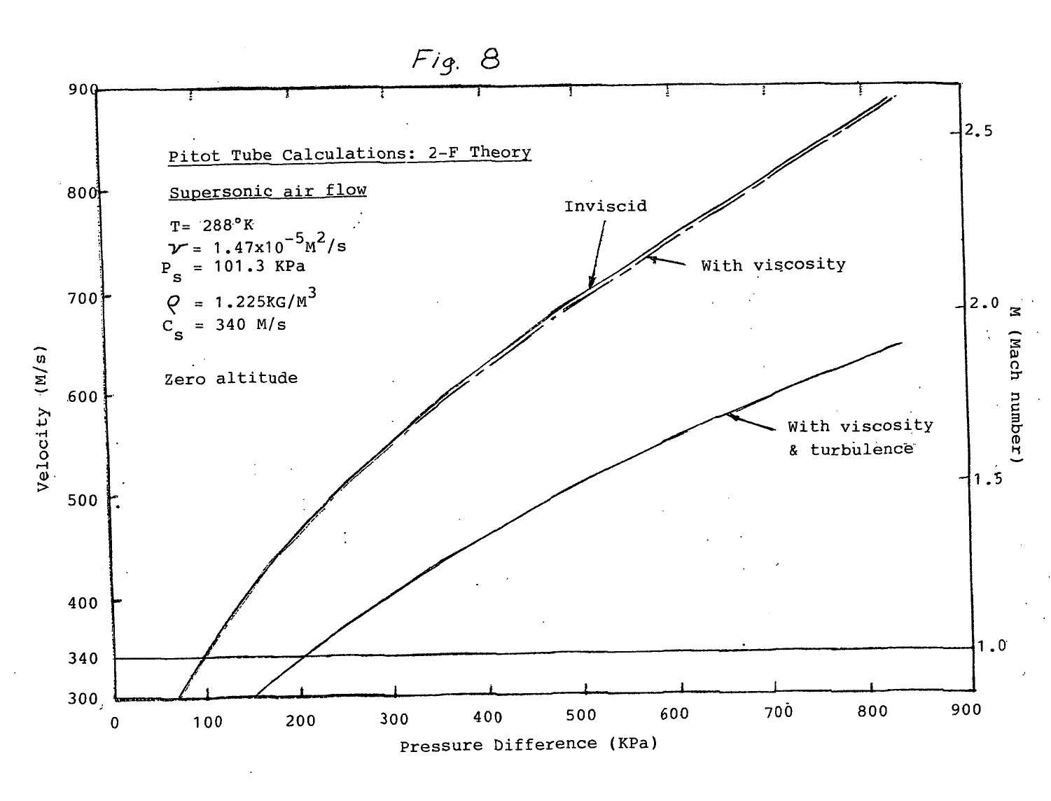

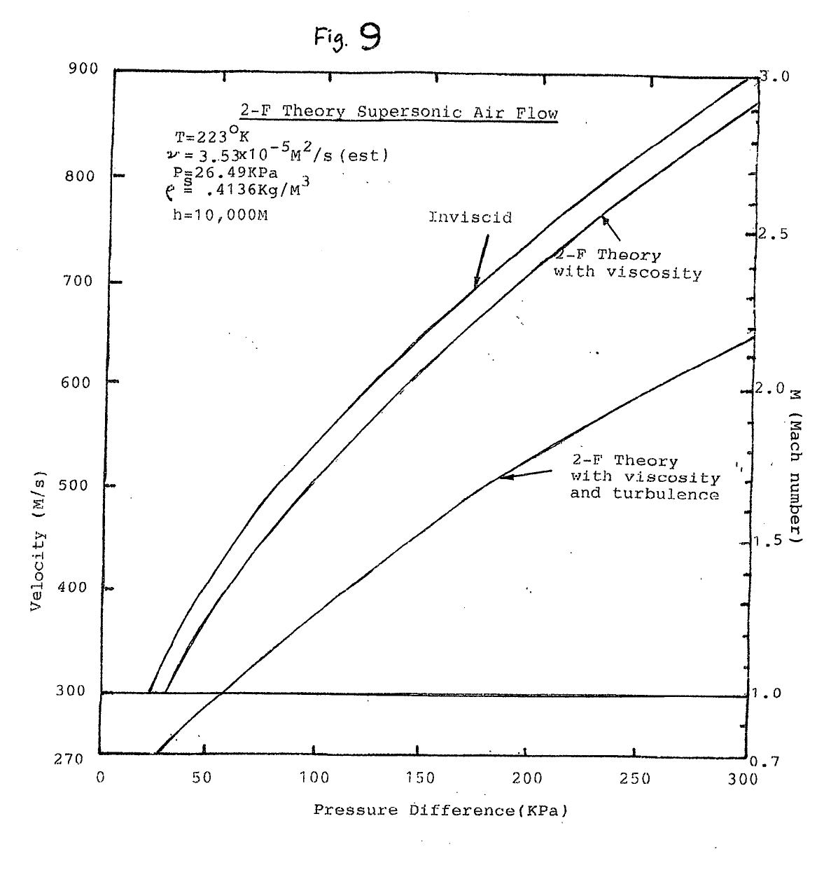

To demonstrate the characteristics of the theory over a wide range of variables amenable to experimental verification, calculations were made for the flow of air into the Pitot tube of FIG. 1 at zero altitude and at 10,000M, for standard atmospheric conditions (STP). Subsonic calculations extended to Mach one; supersonic from 1.0 to 3.0. (FIGS. 6-10)

An estimate was made of the kinematic viscosity at 10,000M since an experimentally determined value was not available. This was done by assuming the dynamic viscosity is independent of pressure and using the value measured for air at −50° C., the ambient temperature for a standard atmosphere at 10,000M. Surprisingly, the resulting value, ν=3.53×10⁻⁵M²/s is over twice the value for air at zero altitude and 15° C., ν=1.47×10⁻⁵M²/s.

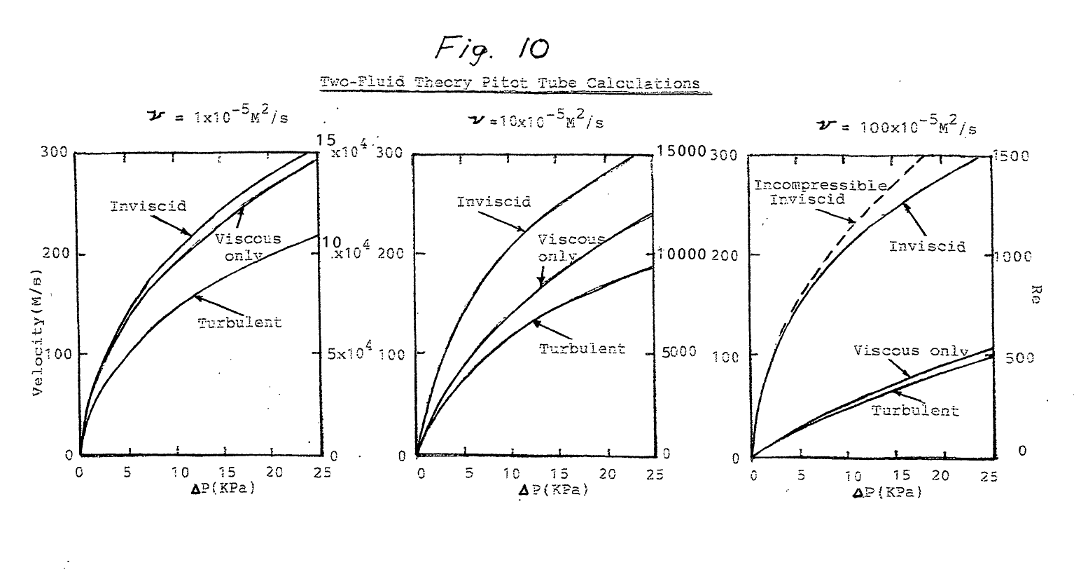

For comparison, results are also presented for air at 10,000M using a range of viscosities spanning two orders of magnitude: 1×10⁻⁵; 10×10⁻⁵; 100×10⁻⁵M²/s. Under severe atmosperic conditions, in the vicinity of a volcanic eruption, for example, or perhaps on a distant planet, such conditions might be encountered. (FIG. 10.)

In these figures, the flow field velocity which would be indicated by the Pitot tube is calculated for three conditions over a range of differential pressures: first, assuming the fluid is inviscid; second, assuming the fluid has viscosity, but does not exhibit turbulence; and lastly, including both viscous effects and turbulence. It is the last values which represent the most realistic representation of real flow behavior.

FIG. 6 presents 2-F Theory calculations for the Pitot tube of FIG. 1 for subsonic air flow at zero altitude. For air without viscosity, compressibility effects are manifested at about Mach one-third; with viscosity and turbulence, compresibility effects are delayed until about Mach one-half.

These results demonstrate that the effect of turbulence on the expected velocity measured by the Pitot tube is much more pronounced than the effect of viscosity until very high values of viscosity are encountered. (Compare the first and third plots of FIG. 10. For ν=1×10⁻⁵M²/s, there is slight difference between inviscid and viscous behavior without turbulence; however, with turbulence the predicted flow velocity is about two-thirds that of the inviscid/viscous values. For a viscosity one hundred times this value, however, turbulence adds very little to the deviation from inviscid behavior: the large viscosity makes a large impact, reducing the “real” velocity to about one-third that of the ideal/inviscid behavior.

These results might be of value to pilots or designers of aircraft in alleviating some of the hazards encounted in flying through heavily contaminated atmospheres on Earth or other planets.

Clearly, treating real fluids as if they were inviscid and in non-turbulent flow can result in significant, even completely unrealistic, results. For example, it is to be noted that at zero altitude between 100 and 200 KPa, the flow is predicted to be subsonic when turbulence is included, but is supersonic using an inviscid fluid analysis. This discrepancy is predicted to occur between 25 and 50 KPa at 10,000M.

The preceding discussion has been presented to illustrate the principles of this invention and is not intended to limit the applicability of the invention to this particular Pitot tube design. There are various design configurations in use for Pitot tubes. This methodology applies to those and also to such devices as Venturi tubes, which are also used to measure flow characteristics using the principles developed in the theory.

I claim that:

1. this invention provides for two Pitot tube designs: one for incompressible, subsonic fluid flow; the other for compressible, supersonic fluid flow; that the designs are comprised of hollow tubes of length 10 cm and internal diameter 0.5 cm, opened at one end to the flow field; connected to pressure measuring devices at the opposite ends of the devices to measure total pressures; surrounded by annuli of 0.25 cm differential radii, sealed at both ends and connected to pressure measuring device to measure static pressures; small bore holes are positioned around the circumferences of the annuli and 1 cm from the flow entrances in accordance with a new theory, the Two-Fluid Theory, developed for this work, to ensure that the viscous component of the flow is fully established; that the device used for supersonic flow is insulated to fulfill adiabatic conditions, its annulus abbreviated to minimize heat loss; and temperature measuring devices can be added to ensure that adiabatic conditions are met, which are not required for the device used for incompressible fluid flow since isothermal conditions are satisfactory, rendering Pitot tubes for such applications much simpler to fabricate, operate and maintain.

2. the devices of claim (1), made of stainless steel, nickel alloy, titanium or other metal or material suitable for the flow field conditions, are supported by rigid frames to the surfaces of aircraft, walls of pipes, or other structures within a flow field at sufficient distances to minimize disruption of the flow;

3. the devices of claims (1) and (2) use a new methodology for converting differential pressure measurements into flow velocities, the Two-Fluid Theory for flow of fluids in pipes, developed by the inventor, which treats real fluids of finite viscosities as a blend of two ideal fluids: an inviscid fluid and a Poiseuille fluid, such that an analysis of the performance of all Pitot tubes can be made, not limited to that described in this invention, to guide the design and calibration of these devices, including the effects of turbulence and viscosity, not covered by present analytical methods.
